(19) United States
(12) Patent Application Publication
(10) Pub. No.: US 2024/0076237 A1
(43) Pub. Date: Mar. 7, 2024

(54) THREE-DIMENSIONAL POROUS NANOCOMPOSITE COOLING FILM AND METHOD OF PREPARING THE SAME

(71) Applicants: Nanjing University, Nanjing, Jiangsu (CN); Haian Institute of High-Tech Research, Nanjing University, Haian, Jiangsu (CN)

(72) Inventors: Shaochun Tang, Nanjing, Jiangsu (CN); Rong Zhang, Nanjing, Jiangsu (CN); Bo Xiang, Nanjing, Jiangsu (CN); Yuchun Shen, Nanjing, Jiangsu (CN)

(21) Appl. No.: 17/904,285

(22) PCT Filed: Nov. 29, 2021
(86) PCT No.: PCT/CN2021/134098

§ 371 Date: Nov. 13, 2023

(30) Foreign Application Priority Data
Feb. 4, 2021 (CN) 202110150147.9

(51) Int. Cl. C04B 26/28; B29C 39/00; C04B 20/00; C04B 38/00; C04B 40/00

(52) U.S. Cl. CPC C04B 26/285; B29C 39/003; C04B 20/0036; C04B 20/004; C04B 38/0054; C04B 40/005; B29K 2001/12

(57) ABSTRACT

Disclosed is a method for preparing a three-dimensional porous nano composite cooling film in large scale. The cooling film is prepared from 0.1-0.5 parts of cellulose acetate, 1-5 parts of water, 20-100 parts of acetone, an additive, and 10-20 parts of nano microspheres through a cooperative formulation of cellulose acetate, nano microsphere materials and the additive. The composite cooling film is obtained by self-deposition of cellulose acetate and nano microspheres, and liquid volatilization during film forming process leads to formation of the three-dimensional porous structure. The film has an effect of enhancing radiation of infrared heat into space, which could significantly reduce a temperature of a substrate surface and achieve rapid and strong cooling. The film could achieve effective cooling without external power and other active cooling equipment, with or without sunlight.

This patent application claims the benefit and priority of Chinese Patent Application No. CN202110150147.9, entitled “Method for preparing three-dimensional porous nanocomposite cooling film in large scale” filed on Feb. 4, 2021, the disclosure of which is incorporated by reference herein in its entirety as part of the present application.

### TECHNICAL FIELD

The present disclosure relates to the technical field of polymer/inorganics composites, in particular to a method for preparing a three-dimensional (3D) porous nanocomposite cooling film.

### BACKGROUND ART

At present, the trend of global warming is intensifying, especially in areas of low latitudes near the equator. Objects which are directly exposed to the sun outdoors, such as buildings and cars, have high internal temperature and need to consume a lot of energy to cool down. Radiation cooling is an effective cooling method. Radiation cooling adopts a basic physical principle that all object surfaces having a temperature greater than absolute zero could radiate energy outward in the form of electromagnetic wave. The outer space outside the atmosphere has a temperature close to absolute zero, and thus is a “cold source”. Infrared radiation could transfer the heat from the earth surface to outer space. The atmosphere of the earth is transparent to infrared radiation (thermal radiation) in an atmospheric window of 7-14 μm.

Passive radiation cooling (PRC) has attracted great attention because it could spontaneously cool a surface by radiating heat into a cold outer space in the form of infrared radiation (8-13 μm), and is highly transparent to its atmosphere. This radiation cooling mechanism leads to the most promising cooling strategy based on pure passive cooling without any additional energy input, such as power, refrigerant and mechanical pump. PRC at night could be achieved only by relying on excellent infrared radiation. However, high-efficient PRC at daytime is still a huge challenge, because only a few percent of solar absorption would offset or even exceed the cooling effect from infrared radiation due to the influence of heat generated by sunlight on the surface. The patent CN102558988A, entitled “High-weather-resistant and environment-friendly heat dissipation cooling coating and preparation method thereof”, discloses a heat dissipation cooling coating prepared by using a micron material additive such as silica, hollow glass microspheres and hollow ceramic microspheres, which has functions of heat dissipation and cooling but could not achieve a passive cooling effect (i.e. a phenomenon that the temperature of the coating is lower than ambient temperature), thus the coating cannot realize a cooling effect under the sunlight in the daytime. The patent CN108250873A, entitled “Outdoor all-weather solar reflection and infrared radiation cooling coating”, discloses a solar reflection and infrared radiation cooling coating prepared by using an additive such as silica, hollow glass microspheres and nano infrared ceramic powder, which has the ability of sunlight reflection and strong infrared radiation, but the preparation method thereof is high-cost and has poor performance repeatability.

Therefore, there are still some defects in the existing technology, in particular that the existing technology can not realize a large-scale preparation of a zero-energy consumption cooling film.

### SUMMARY

The present disclosure provides a method for preparing a three-dimensional porous nano composite cooling film in large scale. In the present disclosure, absorption of sunlight could be reduced due to high reflectivity of the film, and meanwhile excess heat could be removed by thermal radiation to the outside, thereby realizing an effect of passive cooling.

The present disclosure also provides a method for preparing a three-dimensional porous nano composite cooling film in large scale, which allows preparing a three-dimensional cellulose acetate (CA)/nano-microsphere composite cooling film by using cellulose acetate having a 3D structure and a phase-inversion self-deposition process, and constructing a hybrid structure of 3D CA/nano microsphere, and makes it possible to prepare a large-area composite cooling film with low cost, thus having high universality.

Technical solutions of the present disclosure are as follows:

Provided is a three-dimensional porous nano composite cooling film, being prepared from raw materials comprising: 0.1-0.5 parts of cellulose acetate, 1-5 parts of water, 20-100 parts of acetone, an additive, and 10-20 parts of nano microspheres.

In some embodiments, a volume ratio of water to acetone is 1:20.

In some embodiments, the nano microspheres are one or more selected from the group consisting of SiO₂, SiC and TiO₂. In some embodiments, the nano microspheres have a diameter of sphere of 1-800 μm.

In some embodiments, the three-dimensional porous nanocomposite cooling film has micropores.

In some embodiments, the nano microspheres are enriched on one side of the three-dimensional porous nano composite cooling film.

In some embodiments, the additive comprises one selected from the group consisting of N, N-dimethylformamide, hexafluoroisopropanol, and formic acid.

Provided is also a method for preparing the three-dimensional porous nano composite cooling film of the above technical solutions in large scale, comprising the following steps:
S1, weighing and mixing a certain amount of water and acetone in a volume ratio of water to acetone of 1:20 to form a mixed solvent;
S2, dissolving a certain amount of cellulose acetate in the mixed solvent to form a transparent precursor solution;
S3, synthesizing nano microspheres having a uniform size by Stober process, separating by centrifugation to obtain nano microspheres, and subjecting the nano microspheres to a washing with deionized water, and then a drying under vacuum at 70° C. to obtain pre-dried nano microspheres;
S4, dispersing the pre-dried nano microspheres in the precursor solution through stirring by a magnetic mixer at a speed of 400-600 r/min for 4-6 h to form a milky white suspension; and
S5, putting the milky white suspension to a casting machine, and subjecting the milky white suspension to a natural volatilization to obtain a large-area cellulose acetate/nano microspheres composite cooling film, that is, a three-dimensional cellulose acetate/nano microspheres composite cooling film, wherein the composite cooling film has controllable area and thickness.

In some embodiments, in S4, the stirring is performed at a speed of 400 r/min, 50 r/min or 600 r/min. In some embodiments, in S4, the stirring is performed for 4 h, 5 h or 6 h.

In some embodiment, the method further comprises adding the additive along with acetone in S1.

Compared with the prior art, the present disclosure has the following beneficial effects:

Firstly, in the present disclosure, the rapid evaporation of volatile acetone results in the separation of CA and water phase, thereby forming a large number of droplets in the CA matrix. After that, with the evaporation of droplets, many micropores with narrow size distribution are produced. At the same time, nano microspheres are concentrated on one side of the composite film due to gravity deposition.

Secondly, the 3D CA/nano microspheres composite cooling film provided in the present disclosure has the best pore size, and the randomly distributed microspheres have a large volume percentage, which is conducive to highly enhancing solar reflection and infrared radiation.

Thirdly, in the present disclosure, the preparation of the film in large scale is realized by a general production process. A large-area organic/inorganic composite cooling film having a 3D microstructure could be prepared at low cost by a tape casting and natural drying process, which makes it possible to solve the problems of production efficiency and cost.

Fourthly, the organic/inorganic composite cooling film having a 3D structure prepared by the present disclosure shows ultra-high r solar energy and E infrared value, reaching 96% to 95%, and could achieve a temperature up to 6-8° C. lower than that of the ambient environment during the day and night, and thus has a good cooling effect.

It should be understood that any product according to the present disclosure does not necessarily need to achieve all the advantages described above at the same time.

### DETAILED DESCRIPTION OF THE EMBODIMENTS

The present disclosure will be further described in detail below in conjunction with the examples, but the embodiments of the invention are not limited to these examples.

The experimental methods or test methods described in the following examples are conventional methods, unless otherwise specified. The reagents and materials are obtained from conventional commercial channels or prepared by conventional methods, unless otherwise specified.

The present disclosure is now described in detail below in conjunction with the examples.

### Example 1

A three-dimensional porous nano composite cooling film was prepared from the following raw materials: 0.1 parts of cellulose acetate, 1 part of water, 20 parts of acetone, an additive, and 10 parts of nano microspheres.

A method for preparing the three-dimensional porous nano composite cooling film in large scale comprised steps as follows:
S1, 1 part of water and 20 parts of acetone were weighted and mixed in a volume ratio of water to acetone of 1:20 to form a mixed solvent.
S2, 0.1 parts of CA was dissolved in the mixed solvent to form a transparent precursor solution.
S3, nano microspheres having a uniform size were synthesized by Stober process, and then subjected to a separation by centrifugation to obtain the nano microspheres. The obtained nano microspheres were washed with deionized water, and then dried under vacuum at 70° C. to obtain pre-dried nano microspheres.
S4, 10 parts of pre-dried nano microspheres were weighted, and dispersed in the precursor solution through stirring by a magnetic mixer at a speed of 400 r/min for 4 h to form a milky white suspension.
S5, the milky white suspension was placed into a casting machine, and subjected to a natural volatilization, to obtain the 3D CA/nano microspheres composite cooling film.

### Example 2

A three-dimensional porous nano composite cooling film was prepared from the following raw materials: 0.25 parts of cellulose acetate, 2.5 parts of water, 50 parts of acetone, an additive, and 15 parts of nano microspheres.

A method for preparing the three-dimensional porous nano composite cooling film in large scale comprised steps as follows:
S1, 2.5 parts of water and 50 parts of acetone were weighted and mixed in a volume ratio of water to acetone of 1:20 to form a mixed solvent.
S2, 0.25 parts of CA and an additive were dissolved in the mixed solvent to form a transparent precursor solution.
S3, nano microspheres having a uniform size were synthesized by Stober process, and then subjected to a separation by centrifugation to obtain the nano microspheres. The obtained nano microspheres were washed with deionized water, and then dried under vacuum at 70° C. to obtain pre-dried nano microspheres.
S4, 10 parts of pre-dried nano microspheres were weighted, and dispersed in the precursor solution through stirring by a magnetic mixer at a speed of 500 r/min for 5 h to form a milky white suspension.
S5, the milky white suspension was placed into a casting machine, and subjected to a natural volatilization, to obtain the 3D CA/nano microspheres composite cooling film.

### Example 3

A three-dimensional porous nano composite cooling film was prepared from the following raw materials: 0.5 parts of cellulose acetate, 5 parts of water, 100 parts of acetone, an additive, and 20 parts of nano microspheres.

A method for preparing the three-dimensional porous nano composite cooling film in large scale comprised steps as follows:
S1, 5 parts of water and 100 parts of acetone were weighted and mixed in a volume ratio of water to acetone of 1:20 to form a mixed solvent.
S2, 0.5 parts of CA was dissolved in the mixed solvent to form a transparent precursor solution.
S3, nano microspheres having a uniform size were synthesized by Stober process, and then subjected to a separation by centrifugation to obtain the nano microspheres. The obtained nano microspheres were washed with deionized water, and then dried under vacuum at 70° C. to obtain pre-dried nano microspheres.
S4, 10 parts of pre-dried nano microspheres were weighted, and dispersed in the precursor solution through stirring by a magnetic mixer at a speed of 600 r/min for 6 h to form a milky white suspension.
S5, the milky white suspension was placed into a casting machine, and subjected to a natural volatilization, to obtain the 3D CA/nano microspheres composite cooling film having large area.

The present disclosure provides a method for preparing a three-dimensional porous nano composite cooling film in large scale, which allows preparing the cooling film through a cooperative formulation of cellulose acetate, nano microsphere materials and an additive. The composite cooling film is obtained by self-deposition of three-dimensional porous cellulose acetate and nano microsphere materials, and has the effect of absorbing heat, enhancing a heat radiation rate of outward infrared radiation, and significantly reducing a radiation temperature, realizing the effect of rapid and strong cooling. The film could achieve the purpose of effective cooling whether there is sunlight or not, without external power and other active cooling equipment/methods, by combining two mechanisms of 3D composite structure and infrared passive radiation. Meanwhile, the tape casting process is used to prepare a large-area organic/inorganic composite cooling film having a 3D microstructure at low cost, thereby solving the problems of production efficiency and cost.

The preferred examples disclosed above are only used to help explain the present disclosure. The preferred examples neither describe all the details in detail, nor limit the present disclosure to the specific embodiment described. Obviously, many modifications and changes may be made according to the present disclosure. These examples selected and specifically described in the present disclosure intend to better explain the principles and practical applications of the present disclosure, so that those skilled in the art could well understand and make use of the present disclosure. The present disclosure is limited only by the claims and their full scope and equivalents.

What is claimed is:

1. A three-dimensional porous nano composite cooling film, being prepared from raw materials comprising 0.1-0.5 parts of cellulose acetate, 1-5 parts of water, 20-100 parts of acetone, an additive, and 10-20 parts of nano microspheres.

2. The three-dimensional porous nano composite cooling film of claim 1, wherein a volume ratio of water to acetone is 1:20.

3. The three-dimensional porous nano composite cooling film of claim 1, wherein the nano microspheres are one or more selected from the group consisting of SiO₂, SiC and TiO₂, and have a diameter of sphere of 1-80011 m.

4. The three-dimensional porous nano composite cooling film of claim 1, wherein the three-dimensional porous nanocomposite cooling film has micropores.

5. The three-dimensional porous nano composite cooling film of claim 1, wherein the nano microspheres are enriched on one side of the three-dimensional porous nano composite cooling film.

6. A method for preparing a three-dimensional porous nano composite cooling film in large scale, comprising the following steps:
S1, weighing and mixing a certain amount of water and acetone in a volume ratio of water to acetone of 1:20 to form a mixed solvent;
S2, dissolving a certain amount of cellulose acetate in the mixed solvent to form a transparent precursor solution;
S3, synthesizing nano microspheres having a uniform size by Stober process, separating by centrifugation to obtain nano microspheres, subjecting the nano microspheres to a washing with deionized water, and then a drying under vacuum at 70° C. to obtain pre-dried nano microspheres;
S4, dispersing the pre-dried nano microspheres in the precursor solution through stirring by a magnetic mixer at a speed of 400-600 r/min for 4-6 h to form a milky white suspension; and
S5, putting the milky white suspension to a casting machine, and subjecting the milky white suspension to a natural volatilization to obtain a large-area cellulose acetate/nano microspheres composite cooling film, wherein the composite cooling film has a controllable thickness.

7. The method of claim 6, wherein the stirring is performed at a speed of 400 r/min, 50 r/min or 600 r/min; and the stirring is performed for 4 h, 5 h or 6 h.
